(19) United States
(12) Patent Application Publication
(10) Pub. No.: US 2002/0012147 A1
(43) Pub. Date: Jan. 31, 2002

(54) Optical dispersion compensation

(76) Inventors: Neville John Hazell, Kent (GB); David Wall, Kent (GB); Peter Terribili, London (GB); Olivier Gautheron, Montigny-le-Brettonneux (FR); Jose Chesnoy, Paris (FR); Gerard Bourret, Le Ville du bois (FR)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/771,660

(22) Filed: Jan. 30, 2001

(30) Foreign Application Priority Data
Feb. 1, 2000 (GB) 0002286.3

(51) Int. Cl. H04B 10/18; H04B 10/12; H04B 10/00

(52) U.S. Cl. 359/161; 359/173

(57) ABSTRACT

The present invention provides a method of dispersion compensation comprising the steps of:

receiving an optical signal having a number of channels separated by wavelength; and applying dispersion compensation over at least one predetermined wavelength band independently of wavelengths outside the wavelength band,

wherein the wavelength band spans a plurality of channels numbering less than the total number of channels in the signal.

The present invention allows dispersion compensation to be applied to a group of channels within a wavelength band with the use of a dispersion compensation element optimised for the particular wavelength band in terms of dispersion compensation and attenuation. Two or more wavelength bands may be chosen to collectively span a WDM signal. Accordingly, the dispersion compensation characteristics of a number dispersion compensation elements may be collocated to create a favourable dispersion compensation characteristic extending over the bandwidth of WDM signal, without the need to treat each channel individually. A mid-span single device permits 40 channels at 10 Gbits⁻¹ over two bands over a distance of at least 6000 km. The simple configuration allows for rapid implementation.

### FIELD OF THE INVENTION

The present invention relates to dispersion compensation for optical signals. In particular, it relates to dispersion compensation for wavelength division multiplexed (WDM) optical signals.

### BACKGROUND TO THE INVENTION

Optical fibre networks are becoming increasingly important in telecommunications, as they offer favourable bandwidths compared with many other systems. Better utilisation of available bandwidths promises higher data rates and more economical telecommunications.

WDM optical transmission systems allow efficient use of the available bandwidth of an optical fibre by dividing it into a number of independent channels at different wavelengths.

Dispersion of the component wavelengths of WDM signals is an important consideration in the performance of optical fibre systems, affecting either available data rates or distances between optical repeaters. The present limit of 32 channels at 10 Gbits⁻¹ over 4000 km comes from this limitation.

Dispersion compensation involves applying dispersion or wavelength dependent delays to the optical signals in reverse order to that occurring in the optical fibre over a long haul. A conventional approach to dispersion compensation of WDM signals is bulk dispersion compensation in which the entire WDM signal is passed in common through a dispersion compensating element. A limitation of this approach arises from the fact that it is difficult to provide dispersion compensation elements having both suitable dispersion and attenuation characteristics over a sufficiently large bandwidth to compensate adequately all of the channels. Some channels will experience unfavourable dispersion or attenuation characteristics, or both. Another approach to dispersion compensation, aimed at overcoming these drawbacks, involves applying dispersion compensation on a channel-by-channel basis. This allows better system optimisation as it is easier to provide dispersion compensation elements with suitable dispersion and optical attenuation characteristics over the relatively narrow bandwidths of individual channels. This approach provides good system performance but significantly adds to the complexity of a system. For example, the WDM signal must be demultiplexed and remultiplexed either side of the dispersion compensation elements. In submarine optical repeaters there is little room for this at present and with the advent of systems operating with 60 or more channels this approach does not offer an acceptable solution.

### SUMMARY OF THE INVENTION

According to a first aspect of the present invention, a method of dispersion compensation comprises the steps of:

receiving an optical signal having a number of channels separated by wavelength; and

applying dispersion compensation over at least one predetermined wavelength band independently of wavelengths outside the wavelength band,

wherein the wavelength band spans a plurality of channels numbering less than the total number of channels in the signal.

The present invention allows dispersion compensation to be applied to a group of channels within a wavelength band with the use of a dispersion compensation element optimised for the particular wavelength band in terms of dispersion compensation and attenuation. Two or more wavelength bands may be chosen to collectively span a WDM signal. Accordingly, the dispersion compensation characteristics of a number dispersion compensation elements may be collocated to create a favourable dispersion compensation characteristic extending over the bandwidth of a WDM signal, without the need to treat each channel individually. A mid-span single device permits 40 channels at 10 Gbits⁻¹ over two bands over a distance of at least 6000 km. The simple configuration allows for rapid implementation.

The method may include splitting the plurality of channels into two or more wavelength bands, propagating these bands along separate optical paths, wherein dispersion compensation is applied in at least one of the optical paths, and subsequently re-combining the signals at an optical output. Preferably, the signal carried by at least one of the optical paths is amplified to compensate for losses.

Preferably, dispersion compensation is provided by means of a number of lengths of dispersion compensation optical fibre.

As an alternative, the method may include passing the entire optical signal through a band-selective dispersion compensation element adapted to apply dispersion compensation only to channels within a predetermined wavelength band.

Preferably, channels outside the predetermined wavelength band are reflected by a separate optical element.

Preferably, the dispersion compensating element is a photorefractive element or a diffraction grating.

The method may also include imposing a uniform delay to a particular wavelength band to compensate for relative dispersion between two bands.

According to a second aspect of the present invention, a dispersion compensation device for applying dispersion compensation to an optical signal having a number of channels, comprises a dispersion compensation element which is configured to apply dispersion compensation only to a predetermined wavelength band independently of wavelengths outside the wavelength band, the predetermined wavelength band spanning a plurality of channels numbering less than the total number of channels of the optical signal.

In one arrangement, the dispersion compensation device comprises a band splitter which feeds two or more optical paths, wherein at least one of the optical paths comprises a dispersion compensation element.

Preferably, the dispersion compensation element comprises a length of dispersion compensating optical fibre.

In an alternative arrangement, the dispersion compensation device comprises an optical coupler which feeds an optical signal received at an optical input to an optical path having a dispersion compensation element, the dispersion compensation element being adapted to apply dispersion compensation to a number of channels within a limited bandwidth and reflect signals within that bandwidth to an optical output of the optical coupler.

Preferably, the optical coupler is an optical circulator.

Preferably, the dispersion compensation element is a diffraction grating or a photorefractive element.

Preferably, the dispersion compensation device further comprises an optical reflector coupled to the dispersion compensating element to reflect optical signals outside of the predetermined bandwidth.

Preferably, a delay element is provided to compensate for relative between bands. More preferably, the delay element is a length of optical fibre coupled between the dispersion compensation element and the optical reflector.

According to a third aspect of the present invention, a dispersion compensation device comprises a housing having at least one spool of dispersion compensation fibre arranged axially within the housing so as to provide a passage extending along a length of the housing through the core of the spool.

Preferably, the housing is a submarine housing. More preferably, the submarine housing is a casing for an optical repeater.

### BRIEF DESCRIPTION OF THE DRAWINGS

Examples of the present invention will now be described in detail with reference to the accompanying drawings, in which:

FIG. 1 shows an example of a dispersion compensation device according to the present invention;

FIG. 2 shows the dispersion compensation applied by the device of FIG. 2;

FIGS. 3 and 4 show an arrangement for stowing a dispersion compensation device in a submarine optical repeater;

FIG. 5 shows another example of a dispersion compensation device according to the present invention;

FIG. 6 shows a two layer cascade of the dispersion compensation devices shown in FIG. 5;

FIG. 7 shows the dispersion compensation applied by the device of FIG. 6; and,

FIG. 8 shows the use of the dispersion compensation device of the present invention midstream in an optical transmission line.

### DETAILED DESCRIPTION

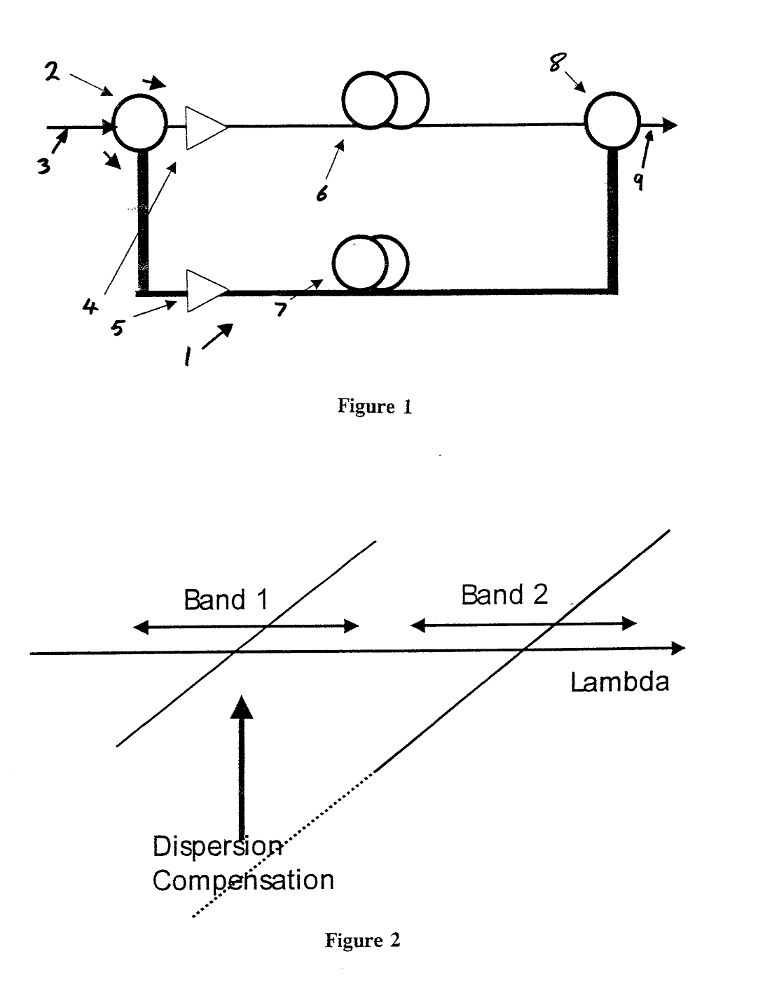

FIG. 1 shows an example of a dispersion compensation device 1 in accordance with the present invention. In this device, an interferometric band splitter 2 having an optical input 3 feeds two propagation paths each having an optical amplifier 4 and 5 and dispersion compensation element 6 and 7, respectively. A band combiner 8 having an optical output 9 is connected to the outputs of each of the propagation paths. In this example, the dispersion compensation elements 6 and 7 are both lengths of dispersion compensating fibre.

In this arrangement, a WDM signal received at the optical input 3 of the interferometric band splitter 2 is divided into two signals, each defining a different wavelength band encompassing a number of channels. Each band then passes through a respective dispersion compensation element 6 or 7 and optical amplifier 4 or 5 before being re-combined with the other band at the band combiner 8.

Each dispersion compensation element 6 and 7 is optimised for a particular wavelength band in terms of both the slope of the dispersion compensation characteristic and the optical attenuation characteristic to account for the accumulation of dispersion due to optical fibre slope in WDM optical long haul transmission. The gain of each optical amplifier 4 and 5 may be selected to compensate for the specific attenuation caused by the dispersion compensation element 6 or 7 and/or wavelength dependent attenuation occurring in long haul transmission.

FIG. 2 shows an example of the relationship between wavelength and dispersion compensation accumulation, illustrating the degree of dispersion compensation applied across the two bands by the respective dispersion compensation elements. The gap between the two bands results from the use of a band splitter and to allow for this the channels of a WDM signal may be clustered with gaps between the clusters.

The dispersion compensation slopes in FIG. 2 show the dispersion compensation accumulation profiles of two different dispersion compensation elements. The dotted line extending from the second of these slopes is included to illustrate the dispersion compensation function that would be obtained by the use of a single dispersion compensation element used to treat the entire WDM signal. This arrangement would highly attenuate some of the channels of the WDM signal. In contrast, the relatively narrow bandwidths treated by the two bandwidth optimized dispersion compensation elements indicated in FIG. 2 provide only low attenuation within each band which can be adequately compensated for by an optical amplifier.

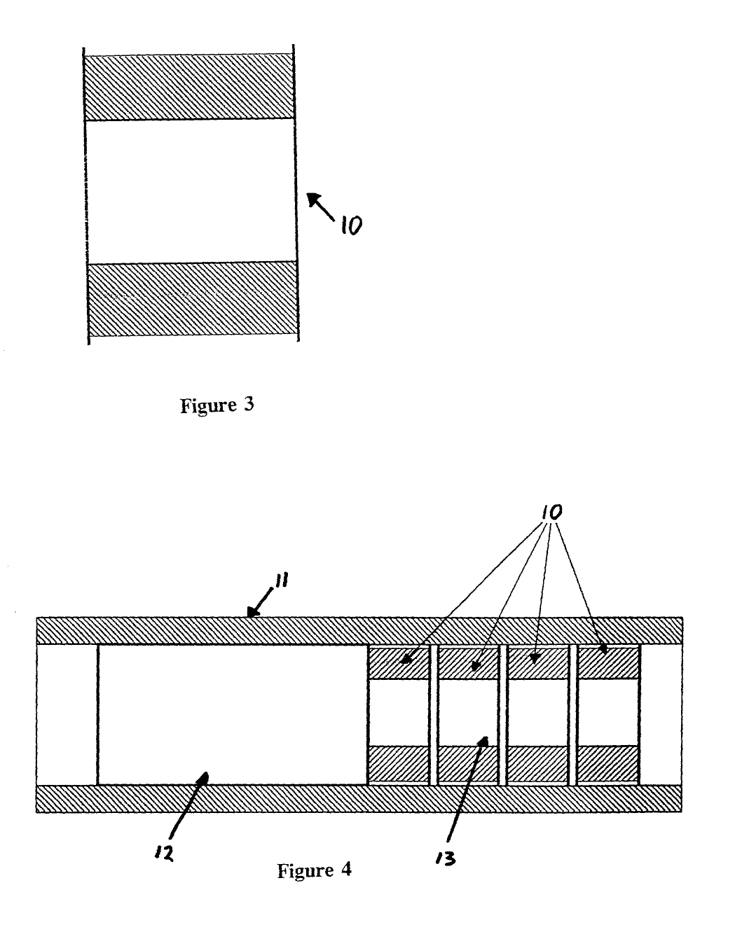

FIGS. 3 and 4 show how spools 10 of dispersion compensating fibre used for the dispersion compensation elements may be fitted within the sea-casing 11 of a submarine optical repeater. The outside diameter of the spool 10 is selected to fit within the internal diameter of a standard sea-casing 11, typically around 200 mm. The internal diameter of the spool is selected to match the minimum bend radius of the optical fibre, which is typically around 50 mm. The height of each spool 10 varies according to the length of fibre used for the dispersion compensation element. Typically, 50 km sections may be used, requiring a spool height of around 100 mm. The spools 10 are arranged at one end of the casing to leave a space 12 at the other end for a number of opto-electronics trays which implement various other functions associated with optical repeaters. The bore of the spools 10 provides a passage 13 for other optical, electrical and mechanical elements.

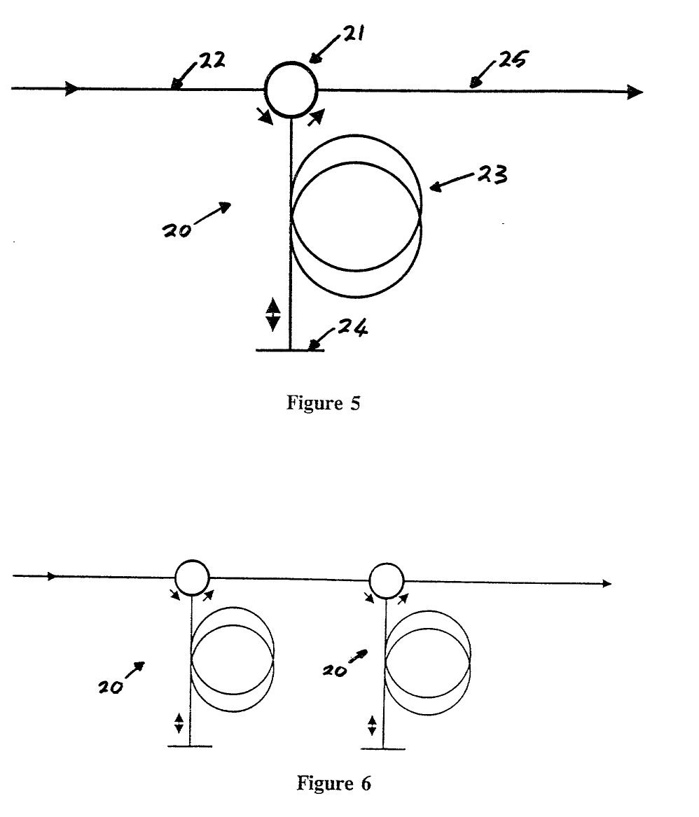

FIG. 5 shows another example of a dispersion compensation device 20 according to the present invention. The device 20 consists of an optical circulator 21 connected to an optical input 22. An optical arm branches from one of the ports of the optical circulator to couple a WDM signal received at the optical input 22 to a band selective dispersion compensation element 23. In this example, the band selective dispersion compensation element 23 may be a photorefractive element or diffraction grating. Beyond the dispersion compensation element 23 at the end of a section of optical fibre is a mirror 24, forming a bulk reflector. The optical circulator 21 couples signals reflected by both the band selective dispersion compensation element 23 and the reflector 24 to an optical output 25.

In this arrangement, the entire WDM signal received at the optical input is coupled via the arm to the dispersion compensation element 23 which applies a wavelength dependent delay to in-band channels and reflects them to the optical output of the optical circulator 21. Out-of-band channels are coupled to the bulk reflector 24 and hence back to the same optical output. A bulk delay may be imposed on out-of-band channels by the additional propagation path length provided by the length of optical fibre. This delay may be chosen to provide inter-band dispersion compensation. It may also be minimised, to be negligible.

The effect of this dispersion compensation device 20 is to apply a dispersion compensation accumulation slope to channels of the WDM signal which lie within the predetermined band affected by the dispersion compensating element 23. Channels outside this band are unaffected, apart from a uniform delay imposed by the (optional) additional optical path to and from the bulk reflector.

FIG. 6 shows a cascaded arrangement for applying dispersion compensation to two wavelength bands. This scheme consists of two of the band selective dispersion compensation devices 20 shown in FIG. 5, in which each of the dispersion compensation elements 23 are selected to compensate different wavelength bands. Any number of the devices 20 can be cascaded to cover the entire bandwidth of a WDM signal to apply compensation to groups of channels. The length of the optical path in each case may be adjusted to provide an extra degree of freedom for relative dispersion compensation between bands. This is in addition to the dispersion compensation within the bands provided by the dispersion compensation elements 23.

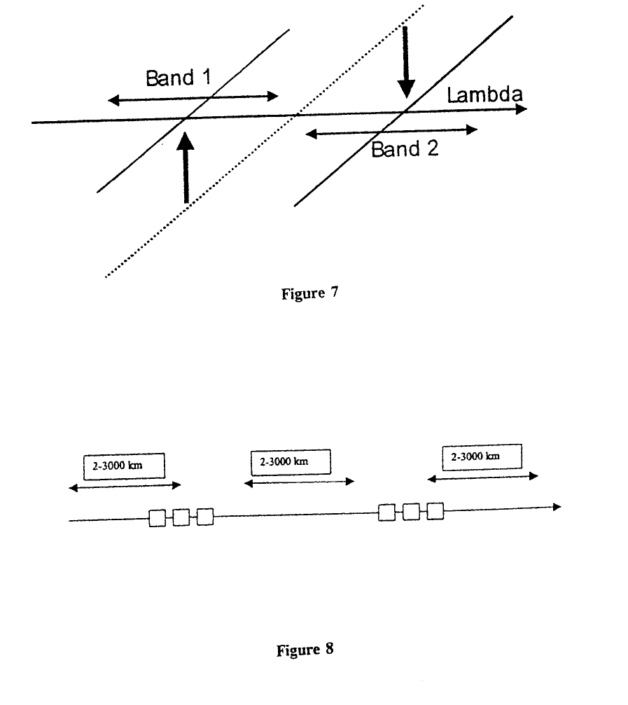

FIG. 7 illustrates the effect of the two-layer cascade shown in FIG. 6, where dispersion compensation has been applied to both bands. In this case band 1 has been relatively delayed and band 2 has been relatively advanced. Within each wavelength band, longer wavelengths have been relatively delayed.

FIG. 8 shows an example of how the dispersion compensation devices of the present invention may be used in a submarine communications system. Dispersion compensation devices within optical repeaters are placed at regular intervals along the length of the submarine cable to process optical signals.

1. A method of dispersion compensation comprising the steps of:
receiving an optical signal having a number of channels separated by wavelength; and, applying dispersion compensation over at least one predetermined wavelength band independently of wavelengths outside the wavelength band, wherein the wavelength band spans a plurality of channels numbering less than the total number of channels in the signal.

2. A method according to claim 1, further comprising the steps of:
splitting the plurality of channels into two or more wavelength bands;
propagating the two or more wavelength bands along separate optical paths, wherein dispersion compensation is applied in at least one of the optical paths; and, subsequently re-combining the signals at an optical output.

3. A method according to claim 2, in which the signal carried by at least one of the optical paths is amplified to compensate for losses.

4. A method according to any preceding claim, in which dispersion compensation is provided by means of a number of lengths of dispersion compensating optical fibre.

5. A method according to claim 1, including the step of:
passing the entire optical signal through a band-selective dispersion compensation element adapted to apply dispersion compensation only to channels within a predetermined wavelength band.

6. A method according to claim 5, in which channels outside the predetermined wavelength band are reflected by a separate optical element.

7. A method according to claim 5 or 6, in which the dispersion compensating element is a photorefractive element or a diffraction grating.

8. A method according to any preceding claim, further comprising the step of:
imposing a uniform delay to a particular wavelength band to compensate for relative dispersion between the particular wavelength band and a second different wavelength band.

9. A dispersion compensation device for applying dispersion compensation to an optical signal having a number of channels, comprising a dispersion compensation element which is configured to apply dispersion compensation only to a predetermined wavelength band independently of wavelengths outside the wavelength band, the predetermined wavelength band spanning a plurality of channels numbering less than the total number of channels of the optical signal.

10. A device according to claim 9, further comprising a band splitter arranged to feed two or more optical paths, wherein at least one of the optical paths comprises a dispersion compensation element.

11. A device according to claims 9 or 10, in which the dispersion compensation element comprises a length of dispersion compensating optical fibre.

12. A device according to any of claims 9 to 11, further comprising an optical coupler arranged to feed an optical signal received at an optical input to an optical path having a dispersion compensation element, the dispersion compensation element being adapted to apply dispersion compensation to a number of channels within a limited bandwidth and reflect signals within that bandwidth to an optical output of the optical coupler.

13. A device according to claim 12, in which the optical coupler is an optical circulator.

14. A device according to any of claims 9 to 13, in which the dispersion compensation element is a diffraction grating.

15. A device according to any one of claims 9 to 13, in which the dispersion compensation element is a photorefractive element.

16. A device according to any of claims 9 to 15, in which the dispersion compensation device further comprises an optical reflector coupled to the dispersion compensating element to reflect optical signals outside of the predetermined bandwidth to the optical output of the optical coupler.

17. A device according to any of claims 9 to 16, further comprising a delay element to provide inter-band dispersion compensation.

18. A device according to claim 17, in which the delay element is a length of optical fibre coupled between the dispersion compensation element and the optical reflector.

19. A dispersion compensation device according to any of claims 9 to 18 comprising a housing having at least one spool of dispersion compensation fibre arranged axially within the housing so as to provide a passage extending along a length of the housing through the core of the spool.

20. A device according to claim 19, in which the housing is a submarine housing.

21. A device according to claim 20, in which the submarine housing is a casing for an optical repeater.

22. A method of dispersion compensation substantially as described herein with or without reference to any of FIGS. 1 to 8 of the accompanying drawings.

23. A dispersion compensation device substantially as shown in and/or described herein with or without reference to any of FIGS. 1 to 8 of the accompanying drawings.
